(19) United States
(12) Patent Application Publication
(10) Pub. No.: US 2012/0047358 A1
(43) Pub. Date: Feb. 23, 2012

(54) METHOD AND SYSTEM FOR ACCELERATING BOOTING PROCESS

(75) Inventors: Chao-Hsiang Chung, New Taipei City (TW); Wei-Chih Lin, New Taipei City (TW)

(73) Assignee: WISTRON CORPORATION, New Taipei City (TW)

(21) Appl. No.: 13/211,290

(22) Filed: Aug. 16, 2011

(30) Foreign Application Priority Data
Aug. 17, 2010 (TW) 99127444

(51) Int. Cl. G06F 9/24

(52) U.S. Cl. 713/2

(57) ABSTRACT

A method and a system for accelerating booting process are provided. The method is adapted to an electronic device having a processor, an embedded controller, and a system memory, in which program codes of a basic input/output system (BIOS) and the embedded controller of the electronic apparatus are commonly stored in the system memory. In the method, when receiving a booting triggering signal of the electronic apparatus, the processor controls the embedded controller to cease accessing the system memory, so as to load the BIOS program code from the system memory to a cache memory and execute power-on self test (POST) procedure. After the program code is loaded, the processor controls the embedded controller to return to a normal mode so as to access the system memory and execute monitoring functions.

### CROSS-REFERENCE TO RELATED APPLICATION

This application claims the priority benefit of Taiwan application serial no. 99127444, filed on Aug. 17, 2010. The entirety of the above-mentioned patent application is hereby incorporated by reference herein and made a part of specification.

### BACKGROUND OF THE INVENTION

1. Field of the Invention

The disclosure relates to a booting method and a booting system, and more particularly relates to a method and a system for accelerating booting process.

2. Description of Related Art

To improve the performance, the electronic device is additionally equipped with an independent embedded controller (EC), besides the processor, to monitor the operations of the peripheral components of the electronic device and the parameters of the system environment so as to assist the processor in managing the peripheral components. For instance, the embedded controller can be used to monitor the brightness of the display, the temperature of the processor, the rotational speed of the fan of the processor, the charging of the battery and the controlling of the built-in keyboard, mouse or touch pad.

Generally, the embedded controller automatically boots without waiting for the booting process of the electronic device after the electronic device is connected to the power source so that the embedded controller can instantly execute the task for monitoring the electronic device. However, based on saving the hardware cost and the occupied space, current processors (such as the processors made by AMD or Intel) adopt the framework of share read-only memory (ROM). That is, the processor and the embedded controller share a serial peripheral interface read-only memory (SPI ROM). The program codes of the basic input/output system (BIOS) and the embedded controller are stored in the SPI ROM. Both of the processor and the embedded controller can access this read-only memory and download the necessary program codes to the cache memory so as to execute the corresponding functions.

Different from the embedded controller that automatically turns on after the electronic device is connected to the power source, the processor accesses the read-only memory and downloads the BIOS program codes from the read-only memory to execute the booting process after the electronic device is powered on (e.g. the user presses the power button). Specifically, at the beginning of the booting process of the electronic device, it is necessary for both of the processor and the embedded controller to access the program codes in the read-only memory. However, the read-only memory only admits one-sided access, and therefore the processor and the embedded controller access the read-only memory in a way of handshaking. In other words, when the processor accesses BIOS program codes, the embedded controller must wait, and when the embedded controller accesses the program codes, the processor must wait. The waiting time for the aforementioned handshaking is the main reason for retarding the booting process of the system.

FIG. 1 is a flow chart of a conventional method for booting an electronic device. As shown in FIG. 1, in the conventional technology, the electronic device is connected to the power source so as to initialize the embedded controller (step S102). After the initialization, the embedded controller starts to execute the task for monitoring the electronic device (step S104). The embedded controller loads the program codes required for the operation of itself from the system memory to the cache memory of the embedded controller so that the embedded controller can execute the task for monitoring the electronic device by executing the program codes. During the embedded controller executes the task for monitoring the electronic device, the electronic device waits for the user to press the power button (step S106). While the user presses the power button, the booting trigger signal is generated and sent to the processor. When receiving the booting trigger signal (step S108), the processor loads the BIOS program codes from the system memory to the cache memory (step S110) so that the power-on self test process is performed (step S112). However, at the time the processor accesses the system memory, the embedded controller also accesses the system memory. Thus, the processor and the embedded controller compete with each other for the resource so that the booting speed of the system is affected.

Accordingly, in order to prevent from the aforementioned resource preemption, it is necessary to stop the embedded controller accessing the memory. R.O.C. Patent No. 1235955 discloses a method for updating the basic input/output system applied in the embedded controller of the electronic device. In this patent, when the program codes of the basic input/output system is updated, the embedded controller is temporally prohibited from accessing the memory, and the update of the basic input/output system of the embedded controller can be accomplished without re-booting the electronic device and using additional memory space. The updating method of this patent is applied while the user wants to update the program codes of the basic input/output system and the system is already booted. Therefore, the aforementioned patent can only prevent the memory accessing error and cannot resolve the problem of retarding the booting process of the system.

### SUMMARY OF THE INVENTION

The disclosure provides a method for accelerating booting process capable of forbidding the embedded controller accessing the system memory during the booting process so as to accelerate the booting process.

The disclosure provides a system for accelerating booting process capable of restoring the embedded controller for continuing executing the monitoring functions after the program codes of the basic input/output system are loaded.

The disclosure provides a method for accelerating a booting process of an electronic device. The electronic device has a processor, an embedded controller and a system memory, wherein program codes of a basic input/output system and the embedded controller of the electronic device are commonly stored in the system memory. In the method, when the electronic device receives a booting triggering signal, the processor controls the embedded controller to cease accessing the system memory and loads the program code of the basic input/output system from the system memory to a first cache memory of the processor to execute a booting process. After the program code of the basic input/output system is loaded, the processor restores the embedded controller to a normal mode so that the embedded controller accesses the system memory and performs a monitoring function.

According to one embodiment of the disclosure, before the aforementioned processor receives the booting triggering signal of the electronic device, the method further comprises connecting the electronic device to a power source to initialize the embedded controller so that the embedded controller executes the monitoring function of the electronic device. The power source comprises an alternating current power source or a direct current power source provided by a battery.

According to one embodiment of the disclosure, the step of executing the monitoring function of the electronic device by the aforementioned embedded controller comprises loading the program code of the embedded controller from the system memory to a second cache memory of the embedded controller and executing the program code of the embedded controller to perform the monitoring function.

According to one embodiment of the disclosure, the step of receiving the booting triggering signal of the electronic device by the processor comprises receiving a triggering signal of a power button of the electronic device, a reset signal of a reset button or a re-booting signal of an operating system.

According to one embodiment of the disclosure, during the booting process is performed by the basic input/output system, the embedded controller continues accessing the system memory and executing the monitoring function.

According to one embodiment of the disclosure, the step of controlling the embedded controller to cease accessing the system memory by the processor comprises controlling the embedded controller to enter an idle mode, a sleeping mode or a hibernation mode so that the embedded controller ceases accessing the system memory.

According to one embodiment of the disclosure, the monitoring function is selected from a group comprising brightness control, temperature monitoring, fan control, battery charging control, keyboard control, touch panel control, status light control and the combination thereof.

The disclosure provides a booting process accelerating system which comprises a processor, an embedded controller and a system memory. The processor has a first cache memory and the embedded controller has a second cache memory. The system memory stores program codes of a basic input/output system and the embedded controller. When receiving a booting triggering signal, the processor controls the embedded controller to cease accessing the system memory and loads the program code of the basic input/output system from the system memory to the first cache memory to execute a booting process. After loading the program code, the processor restores the embedded controller to a normal mode so that the embedded controller accesses the system memory to execute a monitoring function.

According to one embodiment of the disclosure, when the booting process accelerating system is connected to a power source, the embedded controller executes an initialization to load the program code of the embedded controller from the system memory to the second cache memory and to execute the program code of the embedded controller to execute the monitoring function.

Accordingly, in the booting process accelerating method and the booting process accelerating system of the disclosure, when the electronic device receives the booting triggering signal, the embedded controller ceases accessing the system memory and the processor loads the program code of the basic input/output system from the system memory to the cache memory. After the program code is loaded, the embedded controller accesses the system memory to accelerate the booting process.

In order to make the aforementioned and other features and advantages of the disclosure more comprehensible, embodiments accompanying figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a flow chart of a conventional method for booting an electronic device.

FIG. 2 is a block diagram showing a system of accelerating a booting process according to one embodiment of the disclosure.

FIG. 3 is a flowchart showing a method of accelerating a booting process according to one embodiment of the disclosure.

FIG. 4 is a flowchart showing a method of accelerating a booting process according to one embodiment of the disclosure.

### DESCRIPTION OF EMBODIMENTS

The embedded controller and the basic input/output system (BIOS) are the systems independently exist. Except for the general handshaking process, the embedded controller and the BIOS are waiting for each other while loading the program codes. Accordingly, the waiting time is the reason for retarding the system operating speed. Hence, it is necessary to control the embedded controller to cease accessing the system memory timely in order to accelerate the booting process. Since the monitoring function of the embedded controller is continuously performed right after the electronic device is connected to the power source, temporally ceasing the monitoring function at the beginning of the booting process would not affect the operation of the whole system. Therefore, in the disclosure, the embedded controller is controlled to cease accessing the system memory at the time the booting process of the electronic device is performed so that the processor is capable of quickly downloading the program code of the BIOS to execute the booting process and further to accelerate the booting process. The following are detailed descriptions of the embodiments of the disclosure.

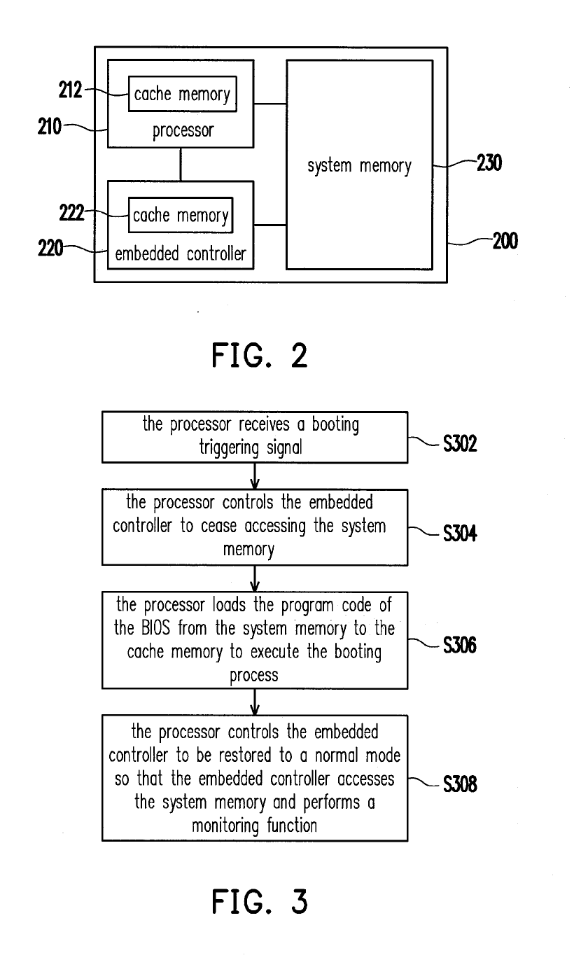

FIG. 2 is a block diagram showing a system of accelerating a booting process according to one embodiment of the disclosure. As shown in FIG. 2, the booting process accelerating system of the present embodiment can be the electronic device 200 includes, for example, a desktop computer, a notebook computer or a personal digital assistant (PDA). The electronic device 200 comprises a processor 210, an embedded controller 220 and a system memory 230. The functions of the components of the electronic device 200 are detailed in the following descriptions.

The processor 210 can be, for example, a central processing unit (CPU), a programmable microprocessor or a digital signal processor (DSP). The system memory 230 can be, for example, a random access memory (RAM), a read-only memory (ROM), a flash memory or other storing medium. The system memory 230 is used as a shared memory of the processor 210 and the embedded controller 220, and the system memory 230 stores the program codes of the BIOS and the embedded controller 220 so that the system memory 230 can be accessed by the processor 210 or the embedded controller 220.

Moreover, the processor 210 has a cache memory 212 and the embedded controller 220 has a cache memory 222. The cache memories 212 and 222 are used to temporally store the program codes to be executed by the processor 210 and the embedded controller 220 respectively so that the processing speed of the processor 210 and the embedded controller 220 can be accelerated. An embodiment is provided hereinafter to elaborate the method for accelerating the booting process of the disclosure.

FIG. 3 is a flowchart showing a method of accelerating a booting process according to one embodiment of the disclosure. As shown in FIG. 3, the method of the disclosure can be applied on the electronic device shown in FIG. 2 and the details of the steps of the method for accelerating the booting process accompanying with the components in the electronic device 200 are elaborated in the following descriptions.

The processor 210 receives a booting triggering signal (step S302). The processor 210 receives, for example, a triggering signal of the power button, a reset signal of a reset button or a re-booting signal sent by an operating system for booting or re-booting the electronic device 200 to perform a power-on self test (POST) process.

When the processor 210 executes the POST process, it is necessary to access the system memory 230 to load the program code of the BIOS into the cache memory 212 of the processor 210. In order to avoid that the embedded controller 220 accesses the system memory 230 at the time the processor 210 accesses the system memory 230, after receiving the booting triggering signal, the processor 210 of the present embodiment controls the embedded controller 220 to cease accessing the system memory 230 (step S304), and loads the program code of the BIOS from the system memory 230 to the cache memory 212 to execute the booting process (step S306). After receiving the booting triggering signal, the processor 210, for example, controls the embedded controller 220 to enter an idle mode, a sleeping mode or a hibernation mode so that the embedded controller 220 ceases accessing the system memory 230.

After the program code of the basic input/output system is loaded, the processor 210 controls the embedded controller 220 to be restored to a normal mode so that the embedded controller 220 accesses the system memory 230 and performs a monitoring function (step S308). The embedded controller 220 ceases accessing the system memory 230 only at the duration of the processor 210 accessing the program code of the BIOS and the duration is about 800 milli-seconds to 1 second, which does not affect the monitoring function of the embedded controller 220 based on the testing result. The monitoring function can be, for example, selected from a group comprising brightness control, temperature monitoring, fan control, battery charging control, keyboard control, touch panel control, status light control and the combination thereof.

In details, as for the function of brightness control, since the electronic device does not display the frame yet at the beginning of the booting process, it is not necessary to control the brightness of the display. As for the function of the temperature monitoring, there is no problem of overheating at the beginning of the booting process of the electronic device and the detection of the overheating takes time to be performed so that the temperature monitoring is not affected by the temporal stop of the embedded controller 220 accessing the system memory 230. As for the function of fan control, the fan control is in response to the result of temperature detection and takes action while the machine is overheated so that the fan control is also not affected by the temporal stop of the embedded controller 220 accessing the system memory 230. As for the function of battery charging control, since the embedded controller operates while it is connected to the power, the battery is charged away before the booting process is performed and the charging process is temporally terminated at the beginning of the booting process so that the battery charging does not affected by the temporal stop of the embedded controller 220 accessing the system memory 230. Usually, the function of keyboard control only acts at the time before the electronic device is turned off or after the display displays the frame so that it is not affected by the temporal stop of the embedded controller 220 accessing the system memory 230. Furthermore, the function of touch panel control is usually used at the time the electronic device entering the operating system so that it is not affected by the temporal stop of the embedded controller 220 accessing the system memory 230. Moreover, as for the function of status light control, the embedded controller turns on the indicating light while the system enters S0 status so that it does not affect the operation of the whole system while the function of the status light control does not take action at the short duration of time in which the display does not display frame.

It should be noticed that the embedded controller starts actions immediately at the time the electronic device is connected to the power source and the embedded controller continues downloading program codes from the system memory to execute the monitoring function. In one embodiment of the disclosure, the embedded controller ceases accessing the system memory within a short time of the duration that the display does not display the frame yet after the user presses the power button so that the time for the processor to access the program code of BIOS is not affected and the booting process is accelerated accordingly. The following is another embodiment for elaborating the booting process of the BIOS after the electronic device is connected to the power source.

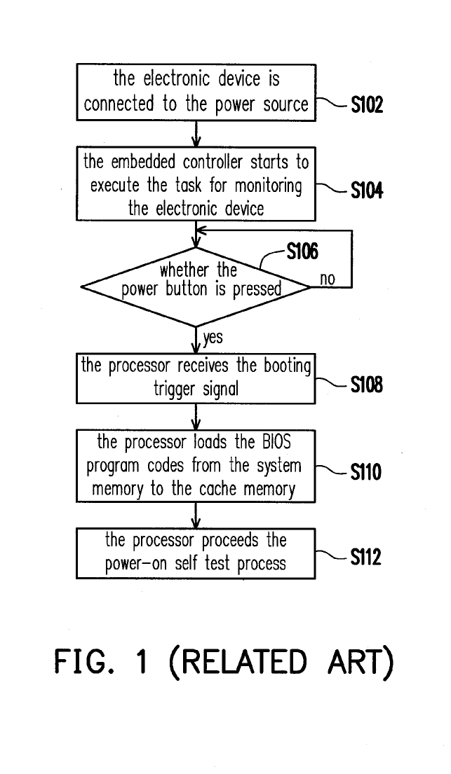

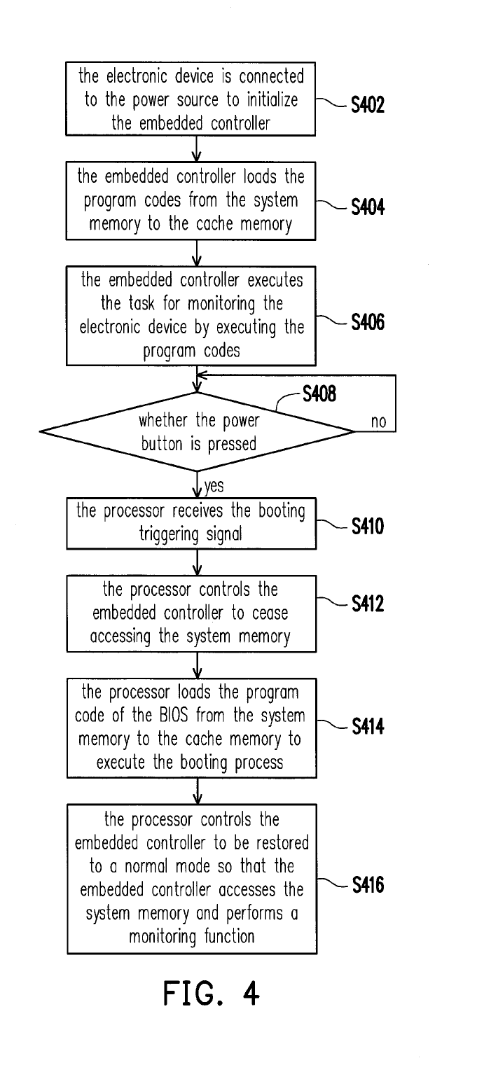

FIG. 4 is a flowchart showing a method of accelerating a booting process according to one embodiment of the disclosure. As shown in FIG. 4, the method of the disclosure can be applied on the electronic device shown in FIG. 1 and the details of the steps of the method for accelerating the booting process accompanying with the components in the electronic device 200 are elaborated in the following descriptions.

The electronic device 200 is connected to the power source to initialize the embedded controller 220 (step S402). The aforementioned power source can be, for example, an alternating current power or a direct current power provided by the battery. That is, the plug of the electronic device 200 is connected to the socket or the battery is inserted into the battery holder of the electronic device 200. When the electronic device 200 is connected to the power source, the embedded controller 220 starts the initialization and after the initialization is completed, the embedded controller 220 starts to execute the monitoring function of the electronic device 200.

In details, the embedded controller 220, for example, loads the program codes required for the operation from the system memory 230 to the cache memory 222 thereof (step S404) so that the embedded controller can execute the task for monitoring the electronic device by executing the program codes (step S406).

During the embedded controller 220 executes the task for monitoring the electronic device, the electronic device 200 waits for the user to press the power button (step S408) to perform the booting process. When the user presses the power button, the booting triggering signal is generated and sent to the processor 210. When receiving the booting triggering signal (step S410), the processor 210 then controls the embedded controller 220 to cease accessing the system memory 230 (step S412) and loads the program code of the BIOS from the system memory 230 to the cache memory 212 to execute the booting process (step S414). After the program code of the BIOS is loaded, the processor 210 further controls the embedded controller 220 to be restored to a normal mode so that the embedded controller 220 accesses the system memory 320 and performs a monitoring function (step S416). Since steps S410 through S416 in the present embodiment are the same as or similar to steps S302 through S308 in the above-described embodiment, the details will not described herein again.

Accordingly, in the booting process accelerating method and the booting process accelerating system of the disclosure, during the time that the processor loads the program code of the BIOS to execute the booting process after the user boots or re-boots the electronic device, the embedded controller enters an idle mode so that the processor can rapidly load the program code and accelerate the booting process. Since the action of the processor loading the program code of the BIOS is only performed once and no resource competition is occurred thereafter, the effect of saving the booting time can be achieved without spending additional cost.

Although the disclosure has been described with reference to the above embodiments, it will be apparent to one of the ordinary skill in the art that modifications to the described embodiment may be made without departing from the spirit of the disclosure. Accordingly, the scope of the disclosure will be defined by the attached claims not by the above detailed descriptions.

What is claimed is:

1. A method for accelerating a booting process of an electronic device having a processor, an embedded controller and a system memory, wherein program codes of a basic input/output system and the embedded controller of the electronic device are commonly stored in the system memory, the method comprising:
receiving a booting triggering signal by the processor;
controlling the embedded controller to cease accessing the system memory by the processor;
loading the program code of the basic input/output system from the system memory to a first cache memory of the processor by the processor so as to perform a booting process; and
after the program code of the basic input/output system is loaded, restoring the embedded controller to a normal mode by the processor so that the embedded controller accesses the system memory and performs a monitoring function.

2. The method of claim 1, wherein before the step of receiving the booting triggering signal by the processor, the method further comprises:
connecting the electronic device to a power source to initialize the embedded controller; and
performing the monitoring function of the electronic device by the embedded controller.

3. The method of claim 2, wherein the step of performing the monitoring function of the electronic device by the embedded controller further comprises:
loading the program code of the embedded controller from the system memory to a second cache memory of the embedded controller; and
executing the program code of the embedded controller to execute the monitoring function.

4. The method of claim 3, wherein the step of receiving the booting triggering signal by the processor comprises:
receiving a triggering signal of a power button, a reset signal of a reset button or a re-booting signal of an operating system.

5. The method of claim 4, wherein the step of controlling the embedded controller to cease accessing the system memory by the processor comprises:
controlling the embedded controller to enter an idle mode, a sleeping mode or a hibernation mode so that the embedded controller ceases accessing the system memory.

6. The method of claim 3, wherein after the step of loading the program code of the basic input/output system, the embedded controller continues accessing the system memory and performing the monitoring function.

7. The method of claim 3, wherein the step of controlling the embedded controller to cease accessing the system memory by the processor comprises:
controlling the embedded controller to enter an idle mode, a sleeping mode or a hibernation mode so that the embedded controller ceases accessing the system memory.

8. The method of claim 3, wherein the monitoring function is selected from a group comprising brightness control, temperature monitoring, fan control, battery charging control, keyboard control, touch panel control, status light control and the combination thereof.

9. The method of claim 2, wherein the power source comprises an alternating current power source or a direct current power source provided by a battery.

10. The method of claim 2, wherein the step of receiving the booting triggering signal by the processor comprises:
receiving a triggering signal of a power button, a reset signal of a reset button or a re-booting signal of an operating system.

11. The method of claim 2, wherein after the step of loading the program code of the basic input/output system, the embedded controller continues accessing the system memory and performing the monitoring function.

12. The method of claim 2, wherein the step of controlling the embedded controller to cease accessing the system memory by the processor comprises:
controlling the embedded controller to enter an idle mode, a sleeping mode or a hibernation mode so that the embedded controller ceases accessing the system memory.

13. The method of claim 1, wherein the step of receiving the booting triggering signal by the processor comprises:
receiving a triggering signal of a power button, a reset signal of a reset button or a re-booting signal of an operating system.

14. The method of claim 13, wherein the step of controlling the embedded controller to cease accessing the system memory by the processor comprises:
controlling the embedded controller to enter an idle mode, a sleeping mode or a hibernation mode so that the embedded controller ceases accessing the system memory.

15. The method of claim 1, wherein after the step of loading the program code of the basic input/output system, the embedded controller continues accessing the system memory and performing the monitoring function.

16. The method of claim 15, wherein the monitoring function is selected from a group comprising brightness control, temperature monitoring, fan control, battery charging control, keyboard control, touch panel control, status light control and the combination thereof.

17. The method of claim 1, wherein the step of controlling the embedded controller to cease accessing the system memory by the processor comprises:
controlling the embedded controller to enter an idle mode, a sleeping mode or a hibernation mode so that the embedded controller ceases accessing the system memory.

18. The method of claim 1, wherein the monitoring function is selected from a group comprising brightness control, temperature monitoring, fan control, battery charging control, keyboard control, touch panel control, status light control and the combination thereof.

19. A booting process accelerating system, comprising:
a processor having a first cache memory;
an embedded controller having a second cache memory; and
a system memory storing program codes of a basic input/output system and the embedded controller, wherein
when receiving a booting triggering signal, the processor controls the embedded controller to cease accessing the system memory and loads the program code of the basic input/output system from the system memory to the first cache memory to execute a booting process, and after loading the program code, the processor restores the embedded controller to a normal mode so that the embedded controller accesses the system memory to execute a monitoring function.

20. The booting process accelerating system of claim 19, wherein when the booting process accelerating system is connected to a power source, the embedded controller executes an initialization to load the program code of the embedded controller from the system memory to the second cache memory and to execute the program code of the embedded controller to perform the monitoring function.
